(19) United States
(12) Patent Application Publication
(10) Pub. No.: US 2004/0205997 A1
(43) Pub. Date: Oct. 21, 2004

(54) Portable heat and gaseous fuel generator that does not require electrical power input or electrical control

(76) Inventor: David Youngblood, Battle Ground, WA (US)

Correspondence Address: OLYMPIC PATENT WORKS PLLC, P.O. BOX 4277, SEATTLE, WA, 98104, US

(21) Appl. No.: 10/417,297

(22) Filed: Apr. 15, 2003

(51) Int. Cl. C10J 1/00; B01J 3/00

(52) U.S. Cl. 48/197 R; 48/61; 48/62 R; 48/89; 48/94; 48/127.9

(57) ABSTRACT

A dual-chamber, aqueous-chemistry-based portable reactor for reducing water via any of numerous possible exothermic reactions to produce both heat and hydrogen gas. In one embodiment, aluminum metal is contained within a lower reaction chamber, an aqueous, sodium-hydroxide solution is contained in an upper chamber, and the aqueous, sodium-hydroxide solution is fed by gravity into the lower reaction chamber to vigorously react with the aluminum metal to produce both heat and hydrogen gas. A static feedback-control tube returns the aqueous, sodium-hydroxide solution back from the second chamber to the first chamber in the event that excessive hydrogen-gas pressure builds up in the second chamber, providing feedback-control of the rate of the reduction of water in the second chamber by a combination of gas pressure and hydrostatic pressure. A heat exchanger within the second chamber removes heat from the second chamber in the form of heated water or other heated liquids or gasses, and by increasing the rate of heat removal, the rate of reduction of water to hydrogen can be decreased, providing a second feedback control. In a second embodiment, a single-chambered reaction vessel is employed.

### TECHNICAL FIELD

The present invention relates to heat-and-gaseous-fuel generators and, in particular, to a portable heat-and-gaseous-fuel generator that employs a reducing agent that reduces water via an exothermic reaction to produce both heat and gaseous hydrogen.

### BACKGROUND OF THE INVENTION

For many years prior to 1973, fossil-fuel energy sources were cheap and widely available for powering automobiles and other vehicles, portable generators, and various motor-driven mechanical devices, as well as for generating heat to heat buildings, residences, water, and for other heating applications. However, after the initial energy crisis of 1973, and continuing increasing cost and questions of availability of fossil fuels, much research has been devoted to finding and exploiting alternative energy sources for these applications. Much research has been conducted on solar-power generation, alternative biomass fuels, nuclear energy, and hydrogen fuel cells. While many of these technologies have matured to the point of usefulness in specific applications, there are still relatively few energy sources and heat and power generation devices, other than traditional fossil-fuel-based generators, that are commercially feasible for portable and remote applications, and for personal, residential, and small-business applications. Thus, a need has continued to be recognized for commercially feasible, environmentally safe, and otherwise non-hazardous heat and power sources for remote applications and for residential, individual, and small-business applications.

### SUMMARY OF THE INVENTION

One embodiment of the present invention employs a dual-chamber, aqueous-chemistry-based portable reactor for reducing water via any of numerous possible exothermic reactions to produce both heat and hydrogen gas. As one example, aluminum metal is contained within a lower reaction chamber. An aqueous, sodium-hydroxide solution is contained in an upper chamber. The aqueous, sodium-hydroxide solution is fed by gravity into the lower reaction chamber to vigorously react with the aluminum metal to produce both heat and hydrogen gas. A static feedback-control tube returns the aqueous, sodium-hydroxide solution back from the second chamber to the first chamber in the event that excessive hydrogen-gas pressure builds up in the second chamber. Thus, the rate of the reduction of water in the second chamber is feedback-controlled by a combination of gas pressure and hydrostatic pressure. A heat exchanger within the second chamber removes heat from the second chamber in the form of heated water or other heated liquids or gasses. By increasing the flow of water or other liquids or gasses through the heat exchanger, the rate of heat removal can be controlled. Increasing the rate of heat removal decreases the rate of reduction of water to hydrogen, and thus can also be used to control the rate of heat and hydrogen production in hydrogen-gas generation.

In a second embodiment, a single-chambered reaction vessel is employed. A reductant is loaded into a reductant vessel within the reaction vessel and exposed to an aqueous solution of sodium hydroxide. Water is reduced to hydrogen gas, and heat is produced. In the second embodiment, the rate of water reduction and concomitant heat production and hydrogen-gas generation is controlled exclusively by controlling the flow of water or other liquids or gasses through the heat exchange component within the single reaction chamber.

### BRIEF DESCRIPTION OF THE DRAWINGS

FIG. 1 shows a front view of the heat-and-gaseous-fuel generator.

FIG. 2 shows the heat-and-gaseous-fuel generator displayed in FIG. 1 rotated 90 degrees to the right, in a semi-cutaway view.

FIG. 3 shows the heat-and-gaseous-fuel generator displayed in FIG. 1 rotated 90 degrees to the left, in a semi-cutaway view.

FIG. 4 shows a top-down view of the heat-and-gaseous-fuel generator shown in FIG. 1.

FIG. 5 shows a reductant vessel employed in a second embodiment of the heat-and-gaseous-fuel generator.

FIGS. 6A-J illustrate feedback control of the water-reduction reaction that proceeds within the lower chamber of one embodiment of the present invention.

### DETAILED DESCRIPTION OF THE INVENTION

One embodiment of the present invention is a portable heat-and-gaseous-fuel generator. FIG. 1 shows a front view of the heat-and-gaseous-fuel generator. Note that FIGS. 1-4 show various views of the heat-and-gaseous-fuel generator, but that all features are not shown in each view in order to simplify the figures for clarity.

The heat-and-gaseous-fuel generator 100 comprises two chambers 102 and 104. The upper chamber 102 is loaded with an aqueous solution of sodium hydroxide, in one embodiment. The lower chamber 104 is the reaction chamber that, in one embodiment, is loaded with metallic aluminum. Both the upper chamber 102 and the lower chamber 104 are vented to the environment through separate pressure relief values 106 and 108, respectively. There is an upper-chamber manual relief value and tube 110 for releasing pressurized liquid and gas from the upper chamber. The upper chamber 102 and lower chamber 104 are interconnected by a formula-feed tube 112 controlled by a formula-feed control valve 114. Both the upper chamber 102 and the lower chamber 104 include visual pressure indicators 116 and 118, respectively, and temperature indicators 120 and 122, respectively. The formula-feed valve 114 is opened in order to introduce the aqueous sodium hydroxide solution, in one embodiment, from the upper chamber 102 into the lower chamber 104 in order to initiate the heat-and-gaseous-fuel generating reaction. Thus, the heat-and-gaseous-fuel generator 100 provides visual indicators, automatic pressure relief valves, and manually operated formula-feed-control and relief valves to allow for full external monitoring and control of the water-reduction reaction that occurs in the lower chamber 104.

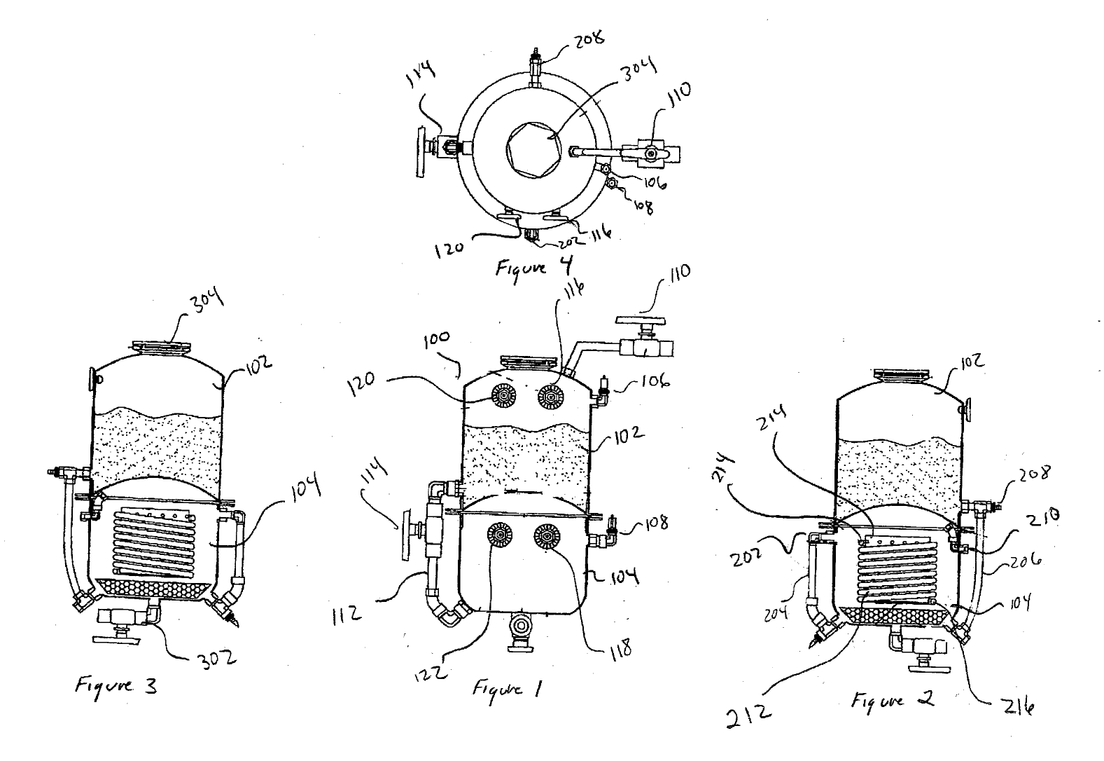

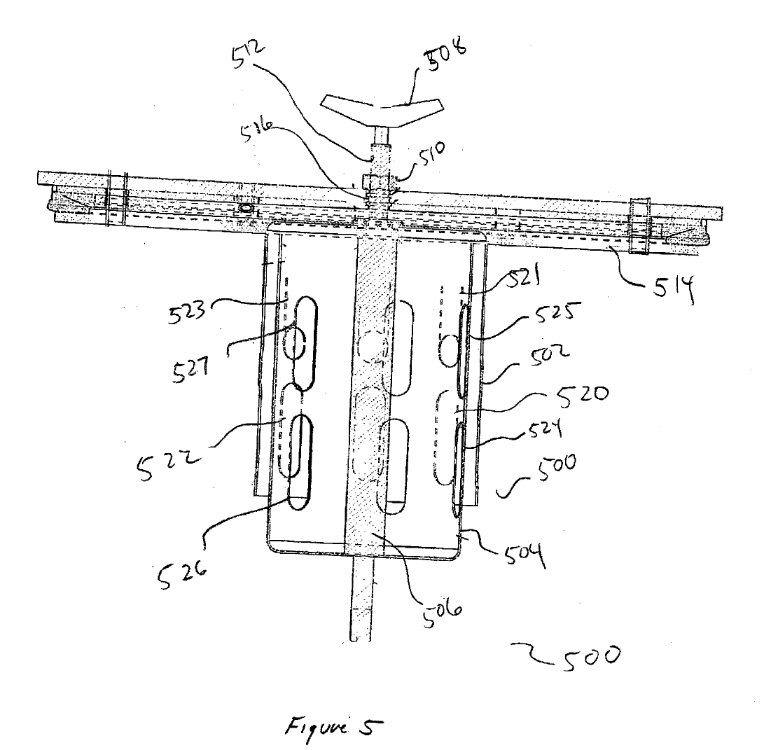

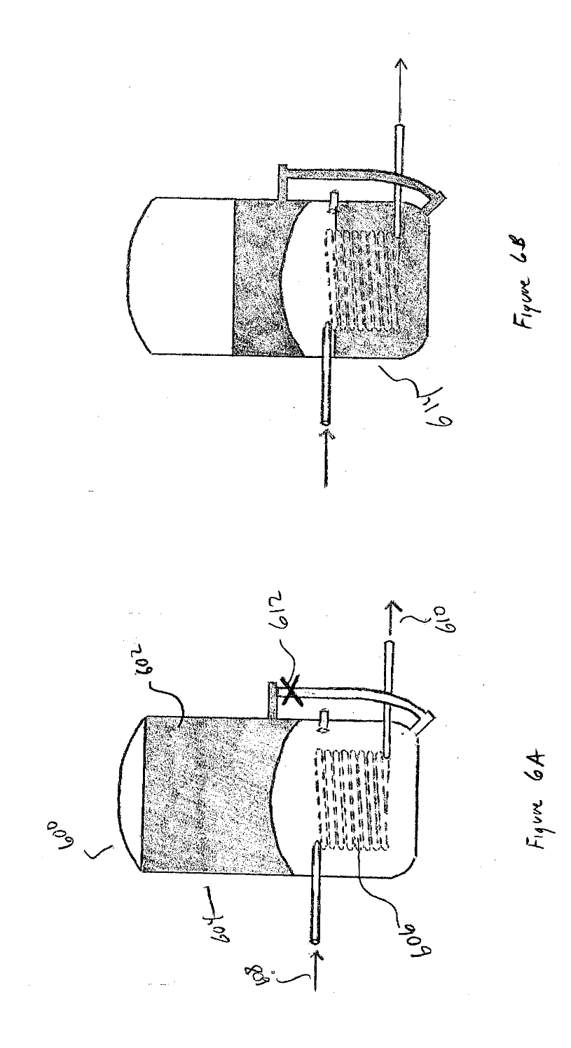

FIG. 2 shows the heat-and-gaseous-fuel generator displayed in FIG. 1 rotated 90 degrees to the right, in a semi-cutaway view. As noted above, certain components displayed in FIG. 1 are not displayed in FIG. 2, to simplify FIG. 2. For example, the formula-feed tube and control valve (112 and 114 in FIG. 1), if shown in FIG. 2, would be centrally disposed on the surface of the heat-and-gaseous-fuel generator. In order to eliminate visual cluttering of the illustrations, FIG. 2 is shown as a partial cutaway view of the heat-and-gaseous-fuel generator.

Several additional features are shown in FIG. 2. The first additional feature is a fluid-level indicator 202 that includes a transparent tubing section 204 for display of the level of aqueous solution within the lower chamber 104. A second additional feature displayed in FIG. 2 is a static control tube 206 and static control valve 208. The static control tube 206 provides a feedback loop so that, if the pressure of hydrogen gas begins to build within the lower chamber 104, aqueous solution is displaced by the pressurized gas through the static control tube 206 back into the upper chamber 102. Removal of aqueous solution from the lower chamber quenches the water-reducing reaction, inhibiting further increase in hydrogen pressure. Thus, the heat-and-gaseous-fuel generator incorporates feedback control for preventing hazardous pressure buildup within the reaction chamber. A third additional feature shown in FIG. 2 is a hydrogen-gas outlet 210 through which hydrogen gas may be expelled from the reaction chamber. The hydrogen-gas outlet 210 may be controlled by a flow-control valve incorporated into the heat-and-gaseous-fuel generator 100, or may be flow controlled further downstream, at the entry point to a hydrogen-gas combustion device or other hydrogen-gas consuming component. A fourth additional feature displayed in FIG. 2 is a heat-exchange-tube coil 212 that surrounds a stainless-steel reactant vessel 214 mounted within the lower, reaction chamber 104. A cooling fluid, such as liquid water, an organic liquid, such as methanol or ethanol, or another liquid or gas, is introduced into the heat-exchange-tubing coil 212 through a first port 214 into the lower chamber 104 and is expelled from the heat-exchange-tubing coil 212 through a second port 216 in the lower, reaction chamber 104. Thus, heat produced by the exothermic water-reduction reaction can be drawn off by a cooling liquid or gas and circulated through a heat-consuming component or device.

FIG. 3 shows the heat-and-gaseous-fuel generator displayed in FIG. 1 rotated 90 degrees to the left, in a semi-cutaway view. Additional components first shown in FIG. 3 include a by-product-recovery-and-reactor drain 302 and a formula-feed plug 304. The by-product-recovery-and-reactor drain 302 allows, in one embodiment, aluminum-hydroxide slurry to be removed from the lower chamber 104. The formula-feed plug 304 can be opened to introduce aqueous solution, such as aqueous sodium hydroxide, into the upper chamber 102. The formula-feed plug is, of course, sealed with an 0-ring or other type of annular sealing device.

FIG. 4 shows a top-down view of the heat-and-gaseous-fuel generator shown in FIG. 1. The disposition of the manual relief valve 110, upper-chamber pressure gauge 116 and upper-chamber temperature gauge 120, fluid-level indicator 202, pressure relief valves 106 and 108, static control tube and valve 208, and the formula-feed valve 114 are clearly shown in vertical projection in FIG. 4.

FIG. 5 shows a reductant vessel employed in a second embodiment of the heat-and-gaseous-fuel generator. In the second embodiment, a single cylindrical-section-shaped chamber is employed primarily for generating heat. The reductant is placed in a reductant vessel 500 which can be controlled to expose the reductant to aqueous solution in order to initiate the heat and gaseous-fuel generation reaction. The reductant vessel comprises an outer canister 502 and an inner canister 504, both supported by a rotatable shaft 506 mechanically interconnected with a handle 508. A threaded, upper portion of the shaft 512 passes through a rotating threaded nut 510 to allow the outer canister 502 supported on a shaft to be tightened against the inner surface of chamber 514. An 0-ring seal is fitted into a groove 516 in order to seal the chamber from the external environment. The inner canister 504 is rotated relative to the outer canister 502 by rotation of the handle 508. The inner canister 504 includes slot-like apertures 520-523 and the outer canister also includes slot-like apertures 524-527. The reductant is placed into the inner canister 504 which is then inserted into the outer canister, and the reductant vessel comprising the inner and outer canister is then held in position by threading the shaft 512 into the rotating threaded nut 510. Initially, the apertures of the inner canister are not aligned with the apertures of the outer canister, preventing ingress of aqueous solution into the inner canister. When the handle is rotated by a small, fixed angle of rotation, the slots of the inner canister and the outer canister become aligned, allowing ingress of aqueous solution and initiation of the water-reduction reaction.

Both the two-chamber heat-and-gaseous-fuel generator shown in FIGS. 1-4, and a single-chamber heat-and-gaseous-fuel generator that represents a second embodiment, use an exothermic chemical reaction to generate heat and gaseous fuel. A useful exothermic reaction is that of aluminum metal with water, the chemical equation for which is shown below:

$$Al + 3 {H}_{2} O ⟶ {Al ( OH )}_{3} + \frac{3}{2} {H}_{2}$$

This oxidation/reduction, or redox, reaction produces prodigious amounts of heat and liberates hydrogen gas. In general, an aqueous solution of sodium hydroxide is employed in this reaction so that the layer of aluminum hydroxide that forms on the surface of aluminum metal is solvated and constantly removed from the surface of the aluminum-metal reductant to allow the aluminum-oxidation and water-reduction reaction to proceed at a vigorous pace. In addition, reaction rates and completeness of the reaction have been found to be more easily controlled and improved by employing a platinum-metal catalyst in the lower chamber, to facilitate reduction of water. In many applications, a few ounces of platinum metal are sufficient to improve rate and completion characteristics. Furthermore, the by-product slurry that is collected from the reaction chamber following oxidation of the aluminum reductant and be filtered to remove AL(OH)₃, and the resulting filtered solution reconstituted for reuse by adding approximately 20% of the amount of sodium hydroxide originally used to prepare the initial aqueous sodium hydroxide solution. The ability to reuse the by-product slurry motivates a third embodiment comprising a continuous-feed heat-and-gaseous-fuel in which by-product slurry may be continuously removed, filtered, and re-introduced into the system, along with continuous resupply of the aluminum reductant. Although the above-described reaction has shown potential for both economic and commercial feasibility for portable, remote applications and for many personal, residential, and small-business applications, many other types of exothermic, gaseous fuel-producing reactions may be used. For example, other elemental metals may be employed to reduce water, including magnesium.

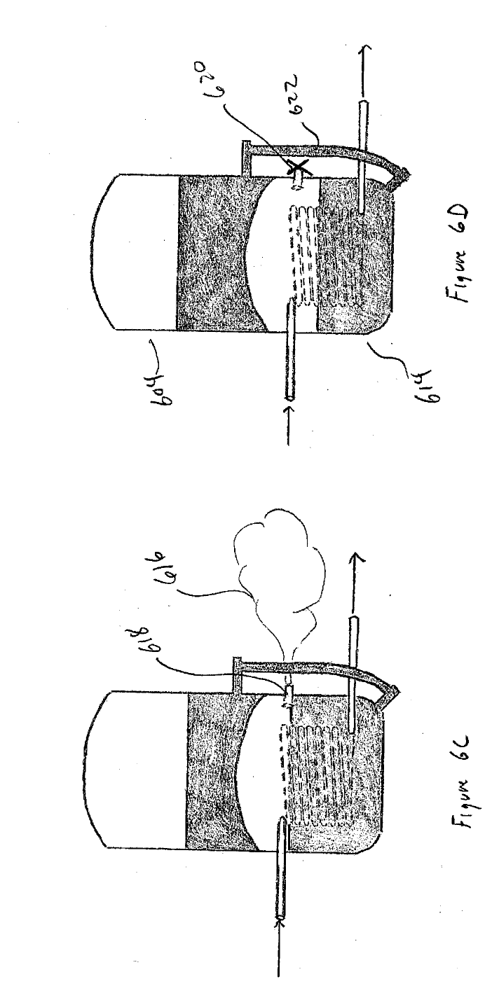

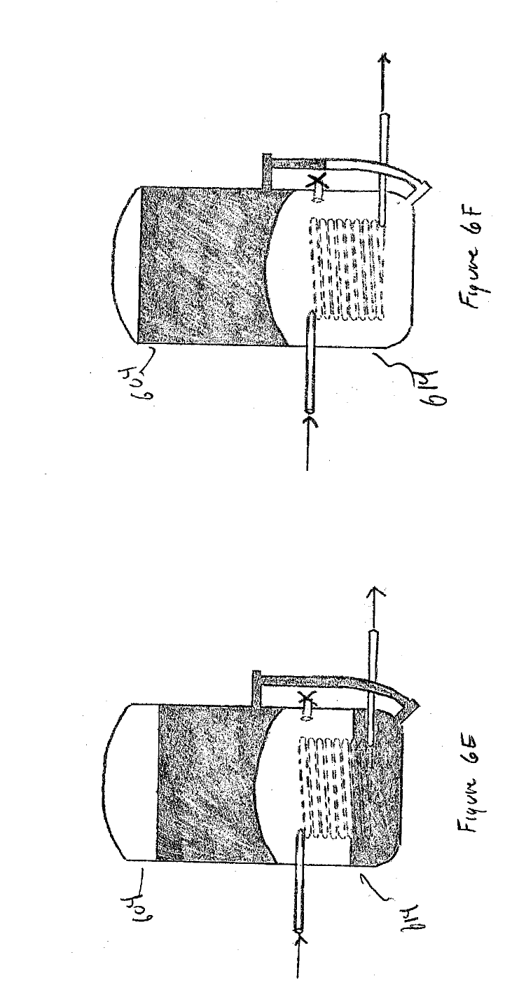

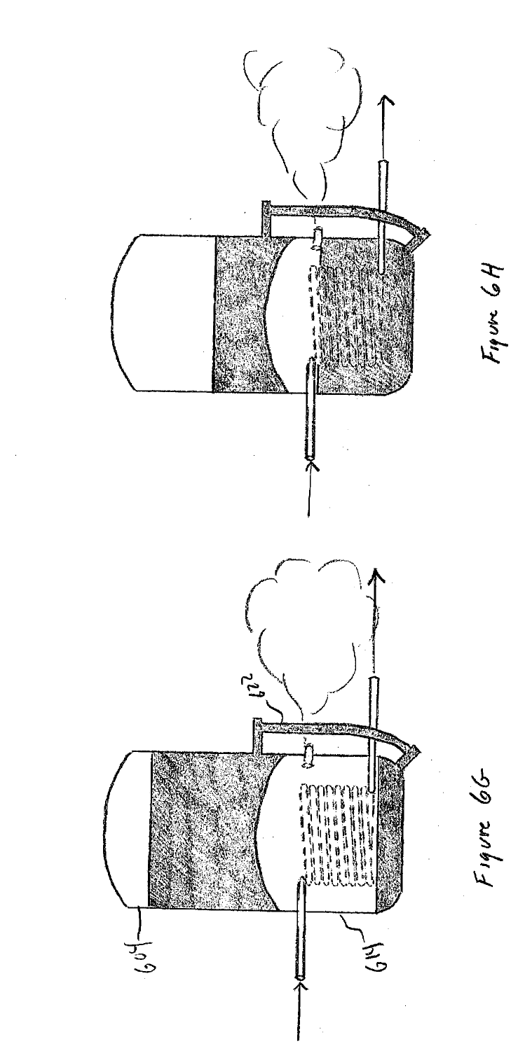

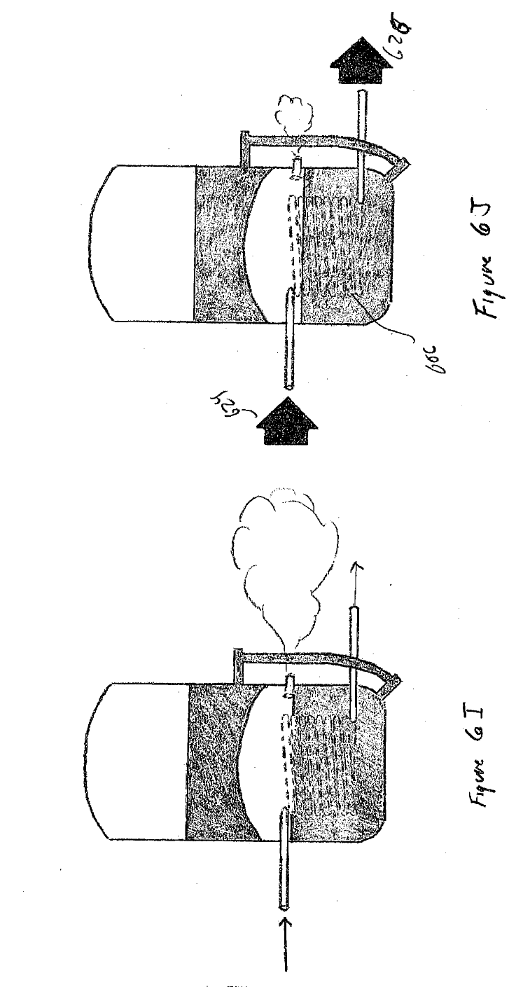

FIGS. 6A-J illustrate feedback control of the water-reduction reaction that proceeds within the lower chamber of one embodiment of the present invention. As shown in FIG. 6A, the two-chamber embodiment may initially have aqueous solution 602 sequestered within the upper chamber 604 and cooling fluid coursing through the heat-exchange-tubing coil 606, indicated by the input 608 and output 610 arrows in FIGS. 6A-J. Initially, the static control valve is closed, as indicated by the “X” symbol 612 in FIG. 6A. Once the formula-feed and static-control valves are opened to allow aqueous solution into the lower chamber 614, as shown in FIG. 6B, the water-reduction reaction is initiated, with the formula-feed control valve closed following introduction of the aqueous solution into the lower chamber. As shown in FIG. 6C, this reaction produces hydrogen gas 616 that is expelled through the gas outlet 618. If, for one of various reasons, the output of hydrogen gas is restricted or blocked, as shown by the “X” symbol 620 in FIG. 6D, hydrogen-gas pressure begins to build in the lower chamber 614. As shown in FIG. 6D, the level of aqueous solution within the lower chamber 614 begins to lower as aqueous solution is expelled from the lower chamber through the static control tube 622 back into the upper chamber 604. As the water-reduction reaction proceeds, with the outlet of hydrogen gas restricted or blocked, additional aqueous solution is expelled from the lower chamber 614 back into the upper chamber 604. If the restriction or blockage of hydrogen-gas output is removed, as shown in FIG. 6G, then the pressure of hydrogen gas within the lower chamber 614 decreases, and aqueous solution again flows through the static-control tube 622 back into the lower reaction chamber 614 from the upper chamber 604. As hydrogen gas continues to be removed from the lower reaction chamber, the level of aqueous solution returns to an equilibrium level, as shown in FIG. 6H. Thus, by simple feedback control, the hydrogen-gas pressure within the reaction chamber can never exceed a safe, relatively low maximum pressure. The rate of water reduction to hydrogen gas may also be controlled purely by the rate of heat removal from the reaction chamber. As shown in FIGS. 6I-J, an increase in the flow rate of cooling fluid through the heat-exchange-tubing coil 606, indicated in FIG. 6J by the large input and output arrows 624 and 626, respectively, slows the water-reduction reaction and therefore decreases the output of hydrogen gas. The rate of water-reduction in the single-chamber embodiment is fully controlled by controlling the rate of heat extraction from the reaction chamber.

The many various embodiments of the heat-and-gaseous-fuel generator, two of which are described above, provide a safe, simple, and commercially feasible source of both heat and gaseous fuel. As noted above, the heat and gaseous-fuel generator is feedback controlled to prevent runaway reaction and overproduction of heat and/or hydrogen gas. It should be noted that this control is maintained without complex electromechanical devices and without the need for electrical power. This further enables the heat-and-gaseous-fuel generator to be portable and to be used in remote applications, where electrical power is not available. When reduced metallic aluminum is used as the reductant for reducing water, and the chemical reaction described above, the resulting aluminum hydroxide, produced as an end-product of the reaction, can be removed from the reaction chamber, dried, and sold as a commercially useful by-product, providing revenue to offset the costs of the sodium hydroxide and aluminum metal. In many cases, the aluminum metal can be obtained at low or no cost, as scrap metal, beverage containers, and other aluminum waste.

Additional compounds may be introduced into the aqueous solution in order to increase the solubility of by-products. As an example, ethylene-diamine-tetraacetic acid (“EDTA”) can be used to maintain magnesium hydroxide in solution when elemental magnesium is employed as a reductant.

There are many different potential uses for various embodiments of the heat-and-gaseous-fuel generator, described above. Applications include production of hydrogen gas in remote locations, where electrical power is unavailable, for use as cooking fuel, fuel for heaters, fuel for generators, and fuel for distilling water. The heat-and-gaseous-fuel generator may be used in marine environments for producing fuel for driving boats and ships, and the water produced by combustion of the hydrogen gas may be recovered for various other uses, including for steam to drive turbines or to cook fish. The portable heat-and-gaseous-fuel generator can be used for remote recreational applications, including lighting, battery charging, cooking, heating recreational vehicles, and may be packaged into small, self-containing canisters for campers, hikers, mountain climbers, and other such outdoor enthusiasts to supply heat, fuel, and clean water. There are emergency back-up applications for the heat-and-gaseous-fuel generator for organizations such as hospitals, businesses, fire departments, etc. Sodium hydroxide and aluminum metal have extremely long half-lives, no toxic by-products are produced, and there are no moving parts or electromechanical systems to fail or degrade, so that the heat-and-gaseous-fuel generator is extremely robust and reliable over long periods of time. Additional applications include employing hydrogen gas from the generator for lighter-than-air vessels, such as hydrogen balloons and zeppelins, for fueling motorized vehicles, either directly, or through hydrogen fuel cells, for agricultural uses, including gas-driven pumps, grow-lamps, feeders, humidifiers, and other such uses.

Although the present invention has been described in terms of a particular embodiment, it is not intended that the invention be limited to this embodiment. Modifications within the spirit of the invention will be apparent to those skilled in the art. For example, many different shapes, sizes, and styles of reactive vessels may be employed to produce to heat-and-gaseous-fuel generators of different shapes and size. A large variety of different materials may be used to produce the vessels and various components and features described above. Care must be taken so that, for example, the heat-exchange tubing is not reactive in aqueous sodium hydroxide, or whatever aqueous solution is used, so that corrosion of components is not a problem. As discussed above, the heat and hydrogen produced by the heat-and-gaseous-fuel generator may be employed for many different uses, and many different types of exothermic chemical reactions may be employed to generate heat and gaseous fuels, including hydrogen. In general, when the above-described As mentioned above, alternative embodiments employ continuous recharging of both the aqueous sodium-hydroxide solution and aluminum-metal reductant, with the by-product slurry continuously removed, filtered, and re-introduced into the heat-and-gaseous-fuel generator.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed, obviously many modifications and variations are possible in view of the above teachings. The embodiments were chosen and described in order to best explain the principles of the invention and its practical applications and to thereby enable others skilled in the art to best utilize the invention and various embodiments with various modifications as are suited to the particular use contemplated. It is intended that the scope of the invention be defined by the following claims and their equivalents:

1. A heat-and-gaseous-fuel generator comprising:
a first chamber containing water;
a second chamber containing a reductant substance, into which water from the first chamber is introduced in order to be reduced, by an exothermic redox reaction, to produce hydrogen gas; and
a static control tube interconnecting the first chamber with the second chamber to provide feedback control for controlling the reduction reaction, with increasing hydrogen pressure in the second chamber forcing water from the second chamber back into the first chamber, thereby decreasing the rate of, or stopping altogether, the redox reaction.

2. The heat-and-gaseous-fuel generator of claim 1 further including:
an automatic pressure relief valve to release pressure from the first chamber.

3. The heat-and-gaseous-fuel generator of claim 1 further including:
an automatic pressure relief valve to release pressure from the second chamber.

4. The heat-and-gaseous-fuel generator of claim 1 further including:
a temperature indicator that displays an indication of the temperature in the first chamber.

5. The heat-and-gaseous-fuel generator of claim 1 further including:
a temperature indicator that displays an indication of the temperature in the second chamber.

6. The heat-and-gaseous-fuel generator of claim 1 further including:
a formula-feed control valve and formula-feed tube that allows water to be introduced from the first chamber into the second chamber.

7. The heat-and-gaseous-fuel generator of claim 1 further including:
a fluid-level indicator including a transparent tube that displays the fluid level in the second chamber.

8. The heat-and-gaseous-fuel generator of claim 1 further including:
a by-product-recovery-and-reactor drain and by-product-recovery-and-reactor valve that allow for reaction byproduct to be removed from the second chamber.

9. The heat-and-gaseous-fuel generator of claim 1 further including:
a heat-exchange-tube coil that surrounds a reductant vessel within the second chamber to allow heat produced by the exothermic redox reaction to be passed into a coolant fluid circulating within the heat-exchange-tube coil and within an interconnected, external heat-consuming device or component, the heat-exchange-tube coil interconnected with the external heat-consuming device or component by tubing that passes through walls of the second chamber by passing through an input and an output port.

10. The heat-and-gaseous-fuel generator of claim 1 wherein the reductant is metallic aluminum and the first chamber contains an aqueous solution of sodium hydroxide.

11. The heat-and-gaseous-fuel generator of claim 10 further including a metallic platinum catalyst within the second chamber that facilitates the reduction of water.

12. The heat-and-gaseous-fuel generator of claim 1 wherein the reductant is metallic magnesium.

13. A method for producing heat and gaseous fuel, the method comprising:
introducing an aqueous sodium-hydroxide solution into a first chamber of a heat-and-gaseous-fuel generator;
introducing metallic aluminum into a second chamber of a heat-and-gaseous-fuel generator;
opening a formula-feed control valve to allow aqueous sodium-hydroxide solution to flow from the first chamber to the second chamber to initiate the reduction of water by aluminum to produce hydrogen gas and heat; and
opening a static control tube interconnecting the first chamber with the second chamber to provide feedback control that controls reduction of water by the metallic aluminum.

14. The method of claim 13 further including introducing a metallic platinum catalyst into the second chamber.

15. The method of claim 14 further including:
periodically removing the by-product aluminum hydroxide slurry from the second chamber; and
filtering and drying the slurry to prepare aluminum hydroxide as a third product of the method.

16. The method of claim 13 further including passing a cooling gas or liquid through a heat exchanger within the second chamber to recover heat from the second chamber to remove heat generated by reduction of water by the aluminum metal within the second chamber, a rate of cooling acting as a second control that controls reduction of water by the metallic aluminum.

17. The method of claim 16 further including passing heated coolant through a heat consuming device in order to recover heat generated by reduction of water by the aluminum metal within the second chamber.

18. The method of claim 17 wherein the heat consuming device may be selected from among:
a water heater;
a residential heater;
an electric generator;
an oven;
a kiln; and
a furnace.

19. A heat-and-gaseous-fuel generator comprising:
a chamber containing a reductant substance, into which aqueous sodium-hydroxide solution is introduced in order to be reduced, by an exothermic redox reaction, to produce hydrogen gas and heat; and
a heat-exchange-tube coil within the chamber to allow the heat produced by the exothermic redox reaction to be passed into a coolant fluid circulating within the heat-exchange-tube coil and within an interconnected, external heat-consuming device or component, the heat-exchange-tube coil interconnected with the external heat-consuming device or component by tubing that passes through walls of the second chamber by passing through an input and an output port, the reduction of water controlled by a rate at which coolant fluid is passed through the heat exchanger.

20. The heat-and-gaseous-fuel generator of claim 19 further including:
an automatic pressure relief valve to release pressure from the chamber.

21. The heat-and-gaseous-fuel generator of claim 19 further including:
a temperature indicator that displays an indication of the temperature in the chamber.

22. The heat-and-gaseous-fuel generator of claim 19 further including:
a fluid-level indicator including a transparent tube that displays the fluid level in the chamber.

23. The heat-and-gaseous-fuel generator of claim 19 further including:
a by-product-recovery-and-reactor drain and by-product-recovery-and-reactor valve that allow for reaction byproduct to be removed from the chamber.

24. The heat-and-gaseous-fuel generator of claim 19 further including a metallic platinum catalyst within the second chamber that facilitates the reduction of water.

25. The heat-and-gaseous-fuel generator of claim 19 further including a reductant vessel within the chamber in which the aluminum metal is contained;

26. The heat-and-gaseous-fuel generator of claim 25 wherein the reductant vessel further includes:
an inner cylinder, with a closed bottom and slot-like apertures, containing aluminum metal; and
an outer cylinder, with a closed top and slot-like apertures complementary to the slot-like apertures of the inner cylinder, in which the inner cylinder is rotatably mounted so that, when the inner cylinder is rotated with respect to the outer cylinder, the slot-like apertures of the inner cylinder are aligned with the slot-like apertures of the outer cylinder to allow aqueous sodium-hydroxide solution to enter the inner cylinder and react with aluminum metal within the inner cylinder.

27. The heat-and-gaseous-fuel generator of claim 26 further including:
a shaft passing through the outer cylinder to which the inner cylinder is mounted;
a threaded nut and O-ring seal that rotatably mounts the shaft and fixedly mounts the outer cylinder to a top wall of the chamber so that the chamber remains sealed; and
a handle mounted to the shaft, external to the chamber, allowing the shaft and inner cylinder to be rotated with respect to the outer cylinder.
